(19) United States
(12) Patent Application Publication
(10) Pub. No.: US 2004/0093569 A1
(43) Pub. Date: May 13, 2004

(54) HDL timing generator

(76) Inventor: Bryan Joseph Colvin SR., San Jose, CA (US)

Correspondence Address: Bryan Joseph Colvin Sr., 4182 Cherry Ave., San Jose, CA, 95118, US

(21) Appl. No.: 10/292,104

(22) Filed: Nov. 13, 2002

(51) Int. Cl. G06F 17/50

(52) U.S. Cl. 716/3; 716/18

(57) ABSTRACT

This invention details an easy method for creating digital hardware timing systems from a text based hardware description language (HDL). Currently, chip designers must represent timing systems as state machines. Once completed, the state machine implementation does not visually resemble the original timing system. Often, a designer will document what the timing looks like by using a comment field; dashes and underscore characters make great looking timing diagrams when a fixed width font is used. A great deal of time may be saved by implementing the timing documentation directly into a state machine programmatically. Also saved is the time required to simulate and debug the state machine implementation. Design engineers are under extreme time pressures; an optimal implementation requires an extensive amount of time. What typically is implemented is the quickest possible solution. Current HDL synthesizers are constrained by what they are given, so the most optimal solution is rarely achieved. A program can be created to examine a plethora of different implementation possibilities and choose the one that creates the least amount of gates. Therefore, not only does the designer save a great deal of time, the design is also highly optimized.

### BACKGROUND OF THE INVENTION

In the old days, schematics were created to design chips and circuit boards. These schematics were replaced with hardware description languages (HDL). State machines written in HDL are much easier to visualize than an implemented design comprising flip-flops and gates. Current HDL languages in use today are Verilog and VHDL. Both of these languages help design engineers to create state machine systems with greater ease. Although timing systems can be implemented as state machines, they lose their visual appeal. The process of converting a timing diagram to a state machine by hand is laborious, and error prone. Optimization is difficult to achieve by hand.

Some graphical entry tools are available on the market (ex: Altera) that can be used to implement some simple timing systems; however, when multiple control signals are required, the graphical entry tool becomes too complex and burdensome to use. There are also severe limitations with respect to how to represent control variables graphically. Some timing constructs are too complex to represent graphically; particularly when there is a multitude of controls. Today, graphical tools are rarely used for design. Instead, text based entry methods are used and preferred. This is because text entry is typically faster than graphical entry. The current trend in the field is to use text base HDL (hardware description language) for all design and verification.

Timing systems often include control signals that can cause the timing to pause. Other control signals may cause the timing to jump or loop to different locations within the pattern. Complex timing systems may require a plurality of timing waveforms, but they all share a common counter state machine. A separate decoder is required for each timing waveform.

Although any timing system imaginable can be implemented using a state machine, the complexity associated with creating a state machine that implements a timing system requires a great deal of time. Because of the time schedule pressures, many engineers do not attempt to optimize the implementation of a timing controller. Instead, they rely on their synthesis tools to do the work for them. Unfortunately, synthesis tools are constrained by the code presented to them. Most designs use the N=N+1 construct to define each state in the state machine that implements the timing system. The N=N+1 construct is quick to type, but forces a binary like counter to be implemented. Binary counters are rarely the most optimal solution.

The process for designing a timing system comprises the following steps: 1) hand draw the timing system, 2) create a state bubble diagram that correlates the hand drawn timing system to state names or state numbers, 3) enter HDL code representing the bubble diagram, 4) enter HDL code representing the decode of the states, 5) create a testbench to stimulate the designed timing system, 6) compile the design and testbench modules, 7) visually examine and compare the simulation result with the hand drawn timing system, 8) if not functional, start over.

### BRIEF SUMMARY OF INVENTION

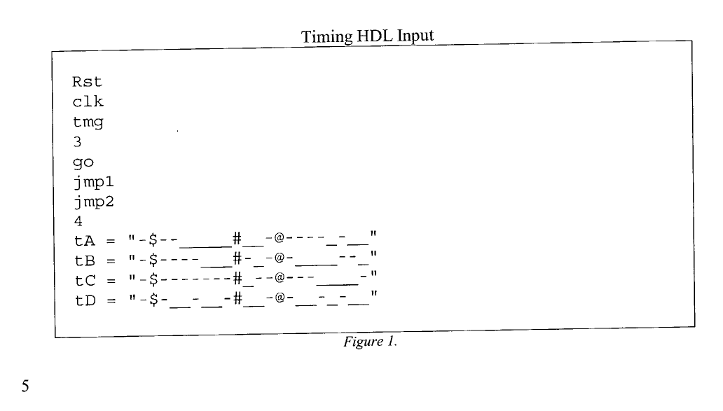

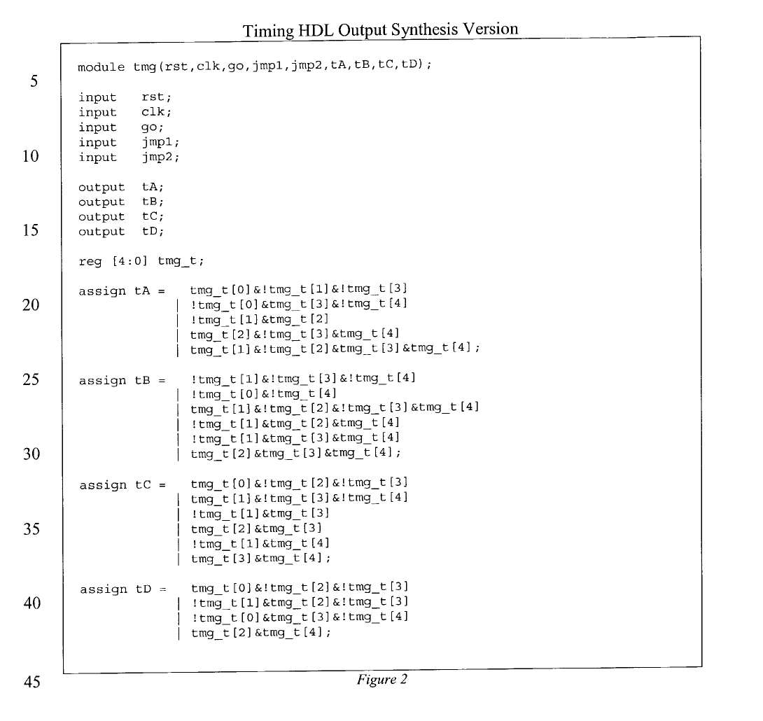

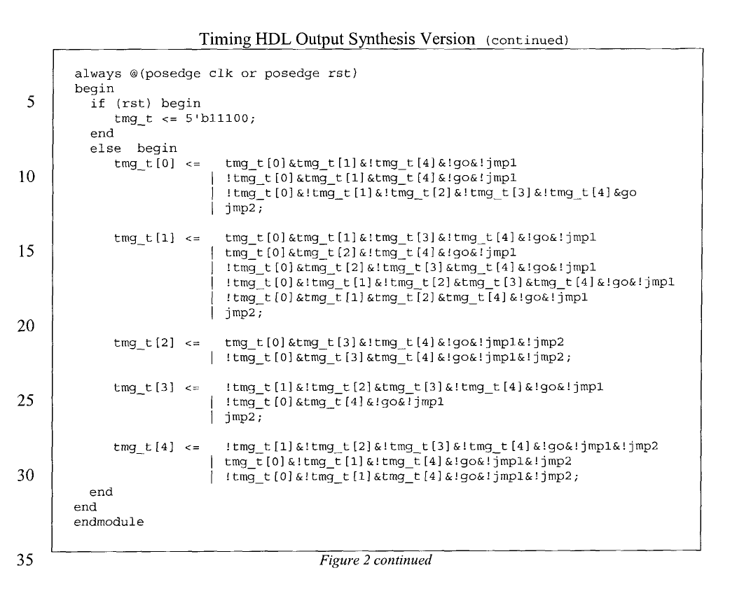

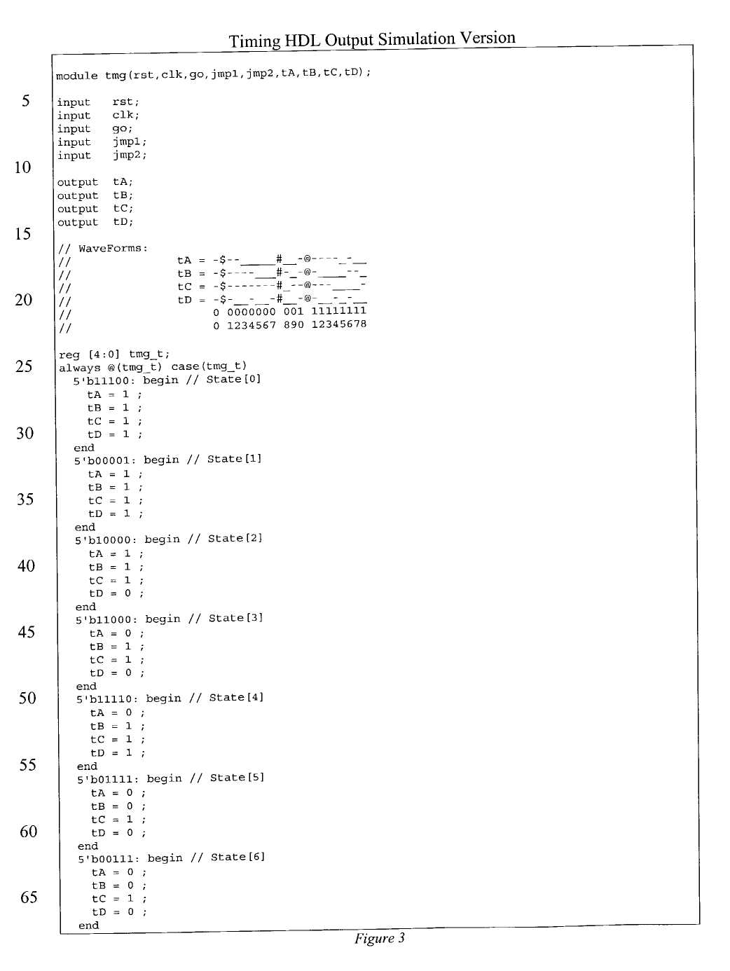

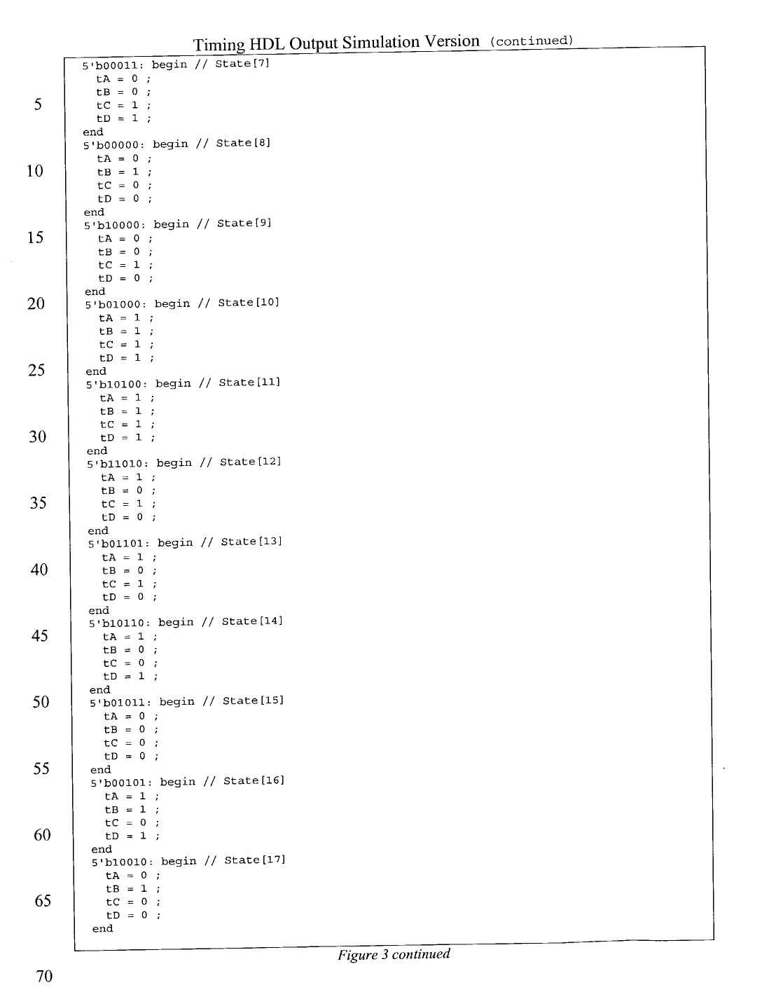

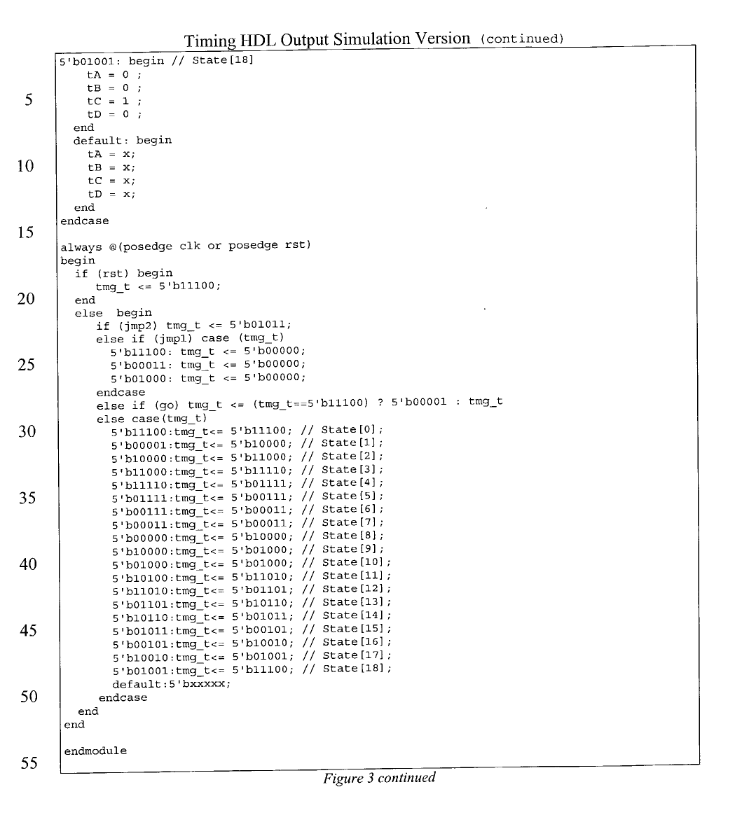

This invention provides a short cut in the design process of creating a timing system by allowing the designer to represent the timing system in a text editor using a fixed width font. This text file is then inputted into a program that implements the state machine representing the timing waveform; the program then outputs a state machine that targets a standard hardware description language (HDL) as shown in FIGS. 2 and 3. The text entered timing syntax is very visual, and removes the need to pre-hand draw the timing system. The preferred embodiment of this invention is to create a simple timing description language that creates a state machine implementation and outputs it to a standard HDL language. This allows the use of existing simulation and synthesis tools. The test input is detailed in FIG. 1.

As can be seen from the code listed in FIG. 1, the code self documents the timing waveform. The first line defines the name for the reset signal. The second line defines the name for the clock signal. The third line is the name of the design. This name is further used to name the states that get used in the state machine that implements the timing system. The forth line dictates the number of timing controls that are used to control the timing system. What then follows is each control name. Under the control names is a number representing the number of timing waveforms. This is followed by the timing waveform equations. Most of the timing uses the dash and underscore characters representing logical states. The first character is the reset state. In this example, all four signals are reset to the high state. The ‘$’ character is a wait control which in this example is controlled by the signal go. After reset, the timing system is frozen at the high state until the go signal is activated high. Timing then proceeds from left to right until the ‘#’ symbol is reached. This also causes the timing to freeze at the state just before the pound symbol. The pound symbol is controlled by the signal jmp1. The control signal ‘jmp1’ is active only when the timing has reached a stopped state. When ‘jmp1’ is activated, timing continues just to the right of the pound symbol. The last remaining symbol ‘@’ is controlled by jmp2. This variable is always active. When ‘jmp2’ is activated, the timing will continue to the right of the ‘@’ symbol. The ‘@’ symbol constitutes a stop point and a jump destination. It also has a higher priority than the other symbols. When multiple symbols with the same priority level are encountered, the priority is determined as left most first. The output of the program creates two Verilog programs: one optimized for synthesis, the other optimized for simulation. The synthesis version is listed in FIG. 2. The simulation version is listed in FIG. 3.

Some of the comments were removed from FIGS. 2 and 3 so that the bare essence of the implementation can be examined. As can be seen, the state machine and output decoder as shown in FIG. 2 is implemented as a series of sum of product equations. Because the design is pre-optimized, the sum of products version (FIG. 2) constrains an HDL synthesis program to use this very precise description. The simulation version is also synthesizeable, but is not as precise. The simulation version is optimized for simulation speed and will simulate faster than the synthesis version. Both versions exhibit the same behavior. The case statements in most HDL languages sometimes infer a priority encoder. Synthesizing the code as detailed in FIG. 3 may cause extra gates to be synthesized. Once the input file has been captured and optimized, the final translation to an HDL language takes a trivial amount of computer time. The optimization process however takes a much longer amount of time. The preferred embodiment of this invention therefore is to produce two outputs for each computer run: one output that targets a synthesizer thereby optimizing gate count, while the other output targets a simulator optimizing simulation speed.

As can be seen from both output listings, there is a substantial amount of work that must take place in order to implement a timing system: particularly one with several control inputs. Additionally, the output code does not visually resemble a timing system as compared to the original source (FIG. 1). The program analyzes 20,000 different state configurations. If a particular configuration falls within a certain window of success, the solution is further optimized. Normal human entry would typically try no more than a dozen configurations. Typically, only the binary assignment is used.

Verilog has very poor support for optimized state assignment. VHDL has excellent support for optimized state assignment. The VHDL language however is very wordy and complex causing many of the designs to target the Verilog language instead. The classic Mealy-Moor State machine has a simplistic output state decoder, which typically comprises a single product row. A timing system however combines a multiplicity of states to form the output decode for the system. Synthesis engines do not consider optimizing the output decoder when optimizing their respective state assignments because most state machines state decoders only require decoding a single state. It is a difficult process to optimize both the state assignment and the state decoder when the state machine is configured as a timing system. Optimizing the state assignment can sometimes cause the output decoder to become less optimal. Optimizing the output decoder can also cause the next state decoder to become less optimal. There may exist an absolute optimal system, but finding such a system is computationally infeasible. Heuristic methods must be employed to search for a solution that is good enough.

### DETAILED DESCRIPTION OF INVENTION

The preferred embodiment of this invention is realized with a software computer program. The program utilizes a command line interface and runs in a command-line shell. The program is written in the C++ language; the program is a functional prototype of this invention. A Person skilled in the art can examine the program source code and make any changes necessary in order to adapt the source code to his respective need. The source code comprises the following files contained on the compact disc:

| | |
|---|---|
| Logic.h | |
| Logic.cpp | |
| Stack.h | |
| StdAfx.h | |
| Timing.cpp | { includes the main( ) function } |
| XString.h | |
| XString.cpp | |
| Timing.dsw , timing.dsp | { non ASCII project files } |

The program documents the command line arguments when no parameters are supplied as follows:

```
>tmgen
usage:
tmgen input_file_name.ext out_base_name
Note: two output files are created:
    out_base_name_v.v (simulation version):
    out_base_name_x.v (synthesis version):
>
```

The test input named “test.tmg”, created two files named: “tmg_x.v and tmg_v.v”. The command line issued was as follows:

tmgen test.tmg tmg

The input code syntax was partially explained in the previous section. A more detailed description is explained here. The Input File Format table as defined in FIG. 4 details each line's syntax.

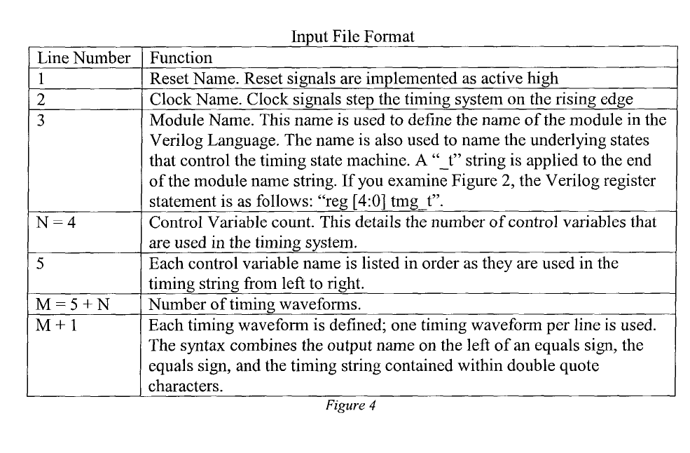

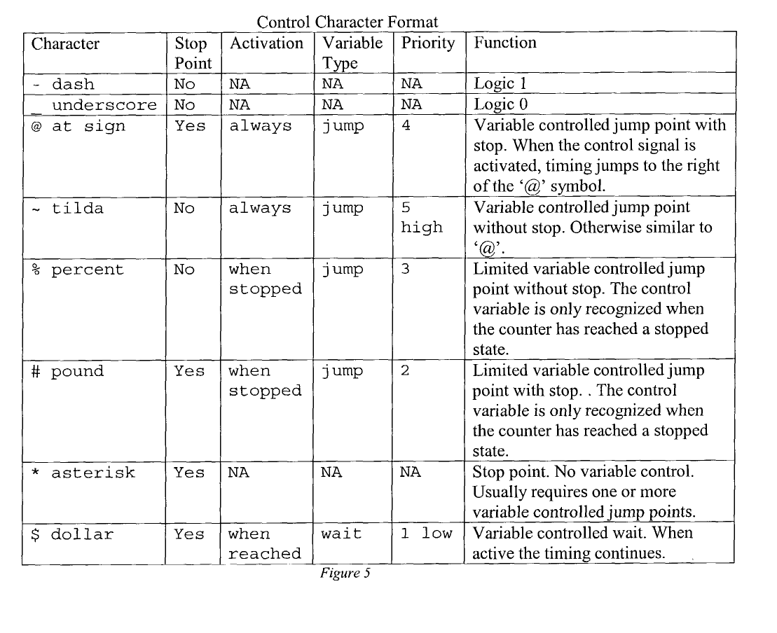

The Timing strings use dash and underscore characters to represent the timing waveforms. Timing proceeds from left to right. The timing string also contains control symbols. Each symbol has a different function. The syntax of the timing string requires the use of a fixed width font. This allows multiple timing variables to line-up under each other. Several characters may be used to control the timing. The timing control character formats are defined in FIG. 5.

Stop points are defined as the point in the waveform where the timing freezes. The logical character just before the stop point defines the repeated state. Some variables are only active when the timing is in a stopped pattern; others are active at all times. These symbols can be interchanged as needed by the designer. A possible expression could be as follows:

“---_---_@-_-_-_---%______”

Some timing systems do not require variable controls. The program allows for this by supplying a zero in the control variable count field (FIG. 1). Because no HDL language currently supports timing constructs, this must be implemented externally; the results can then be pasted back into the main design where needed. It may be possible in the future to include these timing strings in a future HDL language.

The format for the input syntax (see FIG. 1) is somewhat simplistic. A person skilled in the art can make simple adjustments to the input syntax. Other enhancements are possible as well. Several ideas could be implemented by persons skilled in the art to include the following additional features:

1. Provide priority arguments or priority overrides for each control variable. The current program uses default settings. The priority override would simply replace the default setting.

2. Remove number fields and replace with statements such as “rst type reset” and “go type control”. Any configuration conveying the essential information is easily parsed and analyzed by a computer program; a person skilled in the art should have little difficulty creating such a parsing system.

3. Create a superset HDL language (based on existing Verilog or VHDL) that includes the timing string as part of its syntax.

4. Create a new HDL language that includes the timing string as part of its syntax.

5. Add the ability to pipeline the timing system. This can be done by introducing leading space characters in the timing string. Each character space would cause the entire timing chain to be delayed by one state. To implement such a feature all that is needed is to create additional delay elements in the final HDL code. A simple counter function can be used to count the number of leading spaces. These spaces can then be removed in order to create the base timing without the delay.

6. Create repeat sections for very long timing systems. This can be done by using a bracket preceded by a number indicating the number of repeated sections. An example could be as follows: “4[---______]3[--_]”. As an example, the composite sync signal used in the broadcasting industry could be designed using such constructs. Each sub-field could be implemented as a sub timing system. In the said example, a modified program could create two timing systems and two counter systems independently. A counter is a special case of a timing system that could be represented by a simple string expression. A count to 4 could be created by the same engine that handles all timing systems as follows: “______-”. This simple string both describes the count length and its decode. Instead of a fixed number, the repeat sections could also be replaced by a variable. A variable controlled repeat block could facilitate the design of pulse density modulation systems. A binary countdown timer that employs programmable start initialization will facilitate the implementation of the variable controlled repeated timing system. A simple multiplexor can select the different repeated sub-fields.

The program source code contains a fully functional program that was used to generate FIGS. 2 and 3. FIG. 7 details the essential operation of the program as contained in the CD as follows:

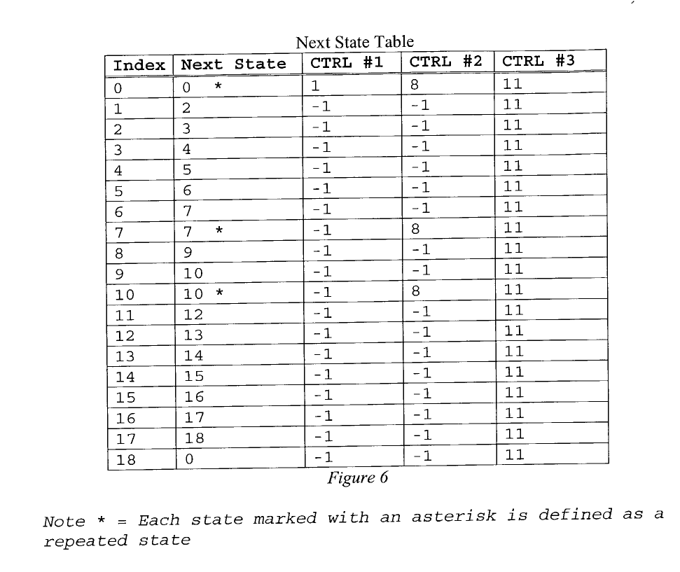

Referring to FIG. 7-1 is an input parser. This block reads the input file and checks the input syntax. The contents of the file are stored into string arrays, which will be used later in blocks 7-13 and 7-15. Block 7-3 is the Next State Table. This table is first initialized with the formula: N=(N+1) % M, where N is defined as the current state index and M the total number of states. In block 7-2, memory is allocated for every state times the number of control variables. FIG. 5 defines what control variables may be used. The State Machine Generator (7-4) further modifies the Next State Table (7-3) by searching for control characters that cause the timing to freeze. The Variable Table (7-2) is initialized with the value −1, which is used as a flag indicating that the control variable is inactive. Some control characters (absolute jumps) are always active, so the −1 initialization values are completely replaced bye the jump location defined as the location just to the right of the respective control character. The dollar character is a variable wait signal; in the Variable table (7-2), a single entry is used to indicate the location of the state just to the right of the dollar sign. All other entries remain initialized to the −1 default. Some variables are active only when the timing string has reached a stop point. The variable Table entries (7-2) for this respective control have entries for each location preceding the stop point; they are replaced with the location of the respective control character just to the right of the respective control character. Once the Next State table (7-3) and Variable Table (7-2) have been fully modified, the state machine (7-4) is then fully constituted. An example of a completed state machine utilizing the Next State Table (7-3) and the Variable Table (7-4) is displayed in FIG. 6. With the completed State Machine Generator tables (FIG. 7-4 and FIG. 6), the Temporary State Map (7-10) is filled with a one-to-one mapping of the binary index of the state machine, which constitutes a replacement state. These replacement states are created by the State Mapping Method (7-5) that is currently being used. This simplest method is the Binary Mapper (7-9). This method simply copies the index state into the mapped state thereby making it look transparent. In other words the original state assignment is unmodified. Each index of the Temporary State Map is filled with the index itself: m[j]=j. Another simple method constitutes the Random State Mapper (7-5). This system simply fills the Temporary State Map (7-10) with random numbers while making sure that the random numbers are not repeated. All mappings must have a one-to-one relationship. The random number generated by the Random State Mapper (7-6) is permitted to use the undefined states that extend beyond the number of states, but do not exceed 2\hat{ }N where N is the number of flip-flops needed to store the states of the state machine. For example, 5 states require 3 flip-flops, meaning that there are a total of 8 possible states. Out of these 8 states, 3 are not used. The random number generator can use any one of these states. The example below shows how a random state-mapping array could be filled:

0->3

1->4

2->7

3->1

4->0

5->2

6->X unused state

7->X unused state

The Shift Register Mapper (7-7) is similar to the random state-mapper, but instead uses a random number to determine the lead bit of a shift-register. This method has the tendency to reduce all but one of the final flip-flop equations. Experimentally, this method had better success in general than the Random State Mapper (7-6). The first state is always initialized with the lead bit set and remaining bits clear: for example, 100000. This initial value has good success because the first N shifts (N=number of flip-flops) will always produce a unique state. In the event that a state is repeated, the procedure chooses the opposite value.

The Decode Optimized Mapper (7-8) tries to minimize the output decode logic by forcing the bits of the state machine to wiggle the same way as the timing. In other words each bit of the state machine actually fully decodes the timing waveform. Sometimes there are holes or repeated states that are not fully covered. Additional flip-flops must then be added to cover these extra states. The number of bits used in the Temporary State Map (7-10) need not be the same number of bits minimally required by the state machine. The example below shows how the initial mapping is performed:

| | |
|---|---|
| A = ″--_{——}″ | (11000) |
| B = ″-_{——}-″ | (10001) |
| C = ″----_″ | (11110) |

| | |
|---|---|
| 01234 | (states) |

| | Map | |
|---|---|---|
| Index | ABC | |
| 000 | 111 | |
| 001 | 101 | |
| 010 | 001 | |
| 011 | 001 | |
| 100 | 010 | |
| 101 | xxx | // unused states |
| 110 | xxx | |
| 111 | xxx | |

Note that the state map 001 is repeated for 010 and 011 indexes. The table can be completed by introducing an ‘additional helper’ state D as follows:

| Index | Map | |
|---|---|---|
| State | ABCD | |
| 000 | 111x | |
| 001 | 101x | |
| 010 | 0011 | |
| 011 | 0010 | |
| 100 | 010x | |
| 101 | xxxx | // unused states |
| 110 | xxxx | |
| 111 | xxxx | |

The state map is now unique. Flip-Flop ‘A’ fully decodes the timing waveform ‘A’ as well as Flip-flop ‘B’ and ‘C’. The output decoder is therefore eliminated. The complexity of the state controller however may be more complex due to the added flip-flops in the system. In the program source code contained on the CD, contains a logic class (Logic.h). This class supports the logic state ‘x’ which means that any logic value can be used. This helps to reduce the logic in the entire system. The concept of introducing don't care states in a Karnough map for the purpose of logic reduction is well understood the art.

A person skilled in the art could come up with additional mapping systems (7-5) to add to the current ones disclosed in this invention. Many more are possible. An example is a gray-code count map. One method may prove superior than another depending upon the waveforms presented to each system. The more methods presented, the more likely an optimal system will be discovered. Given a sufficient number of possible mapping systems, it is unlikely that a human would be able to create a mapping that would return a superior score.

After each mapping is completed, a scoring generator function (7-11) determines how good the result is. When a good score is discovered, the temporary State Map is eventually stored in the Best State Map memory (7-12). It may be useful to keep several versions around. The Current program saves only the best score. Before the Best score is saved, the Temporary State Map (7-10) can sometimes be improved by running the optimization routine on it. The decision to optimize (7-17) is based on whether or not the score falls within a certain percentage of the best score. The optimization routine takes a good deal of time, and it was discovered that a bad mapping does not get much better after optimization. To this end, it is preferred to not run the optimizer on every solution in order to make the program perform faster. One possible implementation could save the best 10 scores, then optimize each of these 10 in order to find the overall best solution.

The program utilizes an optimization routine (7-16) that rearranges a given state assignment mapping until it finds the best arrangement. In a complex system with many variables, an optimization process can be achieved by tweaking a single variable until the system is optimized around that variable. Later a different variable is chosen attempting to make it optimal. This process is then repeated until every variable has in turn has been optimized. Because of interdependencies, the system is still not optimized, but instead the system is improved. By repeating the process a multiple number of times, there will come a point where no single change of any single variable will further optimize the system. An analogous strategy was employed in this system. In the source code, each variable constitutes a state map location. State maps (7-10) must have a one-to-one correlation meaning that there cannot be any repeated state mappings. The optimization routine in the program listing (Timing.cpp) performs state swapping. Each state map location is swapped with other state map locations until an improvement is discovered. Once this takes place, the next state map location is swapped will other states until further optimization is realized. After each swap operation, a scoring function (7-11) in the form of a sum of product expression is used to evaluate each trial solution. Each “AND”, “NOT”, and “OR” term is weighted and summed. Both the output decoder and the next state decoder scores are summed in order to create the final score. The scoring function (7-11) could be modified by a person skilled in the art to include logical partitioning reductions. Logic partition theory is contained within the mathematics of set and graph theory. Consider a function of five variables: x=f(a, b, c, d, e). The function can be partitioned into three sections by using the following expansion method: x=a & f1(b, c, d, e)+!a & f2(b, c, d, e)+f3(b, c, d, e). This can then be further partitioned as follows:

$$\begin{matrix}X = a & \& & ! b & \& & f4 ( c , d , e ) + \\ a & \& & b & \& & f5 ( c , d , e ) + \\ a & & & \& & f6 ( c , d , e ) + \\ ! a & \& & ! b & \& & f7 ( c , d , e ) + \\ ! a & \& & b & \& & f8 ( c , d , e ) \\ ! a & & & \& & f9 ( c , d , e ) + \\ & & b & \& & f10 ( c , d , e ) + \\ & & ! b & \& & f11 ( c , d , e ) + \\ & & & & f12 ( c , d , e )\end{matrix}$$

This expanding operation can be taken to the point where there remains only functions of two variables. The function of two variables typically collapses into trivial solutions. There are 16 different sub-functions of two variables as follows:

$$\begin{matrix}F ( a , b ) … & \\ ( 0 , 1 , a , b , ! a , ! b ) & Collapse \\ ( a \& b , ! a \& b , a \& ! b , ! a \& ! b ) & AND \\ ( a + b , ! a + b , a + ! b , ! a + ! b ) & OR \\ ( \hat{a b} , ! \hat{a b} ) & XOR\end{matrix}$$

When all equations in the system have been expanded, each function of two variables can then be collected or combined. In a large system, many functions will either collapse or combine. Many solutions are possible. Instead of starting with the extraction of ‘a’, ‘e’ could be used instead. The extraction order could be: b, d, a. Different extraction orders typically result in a different partition and may constitute more logic elements. At each step of extraction, each sub-function is compared to see if it is possible to combine, or if that expression has collapsed. If for example f4( ) and f5( ) were equal, the expression for X would reduce as follows:

$$\begin{matrix}X = a & & & \& & f4 ( c , d , e ) + \\ a & & & \& & f6 ( c , d , e ) + \\ ! a & \& & ! b & \& & f7 ( c , d , e ) + \\ ! a & \& & b & \& & f8 ( c , d , e ) \\ ! a & & & \& & f9 ( c , d , e ) + \\ & & b & \& & f10 ( c , d , e ) + \\ & & ! b & \& & f11 ( c , d , e ) + \\ & & & & f12 ( c , d , e )\end{matrix}$$

The time required for this partitioning operation may cause excessive delay in the evaluation routine; therefore, partitioning was not included in the preferred embodiment program. The scoring function (7-11) could also be modified to also include a score for propagation speed. This is done by partitioning the logic as was previously mentioned. A propagation speed can then be estimated for each partition delay path. A delay path is defined as a given input mapping to a given output. The largest delay path constitutes the score for the entire logical system. Typically, the clock speed determines the absolute maximum delay path permitted by the system; this includes both the state machine internal state propagation and the output decoder delay. The delay path must additionally consider setup time and clock to Q of the targeted flip-flop. Estimated wiring delays must also be considered. When the delays of both the output decoder and the next state decoder fall within a reasonable margin, the scoring function can then consider gate count. Because logic partitioning causes the program to execute longer, and because logic partitioning is necessary for speed estimation, it has not been including in the program source code. A person skilled in the art can modify this program to include speed optimization by selecting a smaller number of solutions that fall within a certain window of success based upon the smaller gate count solution. The best 10 solutions then could be fully partitioned with the score modified based on either speed or gate count.

The source code includes a logic class (logic.cpp) that performs sum of product reductions. The logic class also provides for the entry of “don't care” states thus allowing further minimization. Further improvements could be made to this class to include logic partitioning.

State machine mappings (7-5) are created in memory arrays. In the initial timing, each timing transition is given an index number. Using the input code as detailed in FIG. 1, the indexes are assigned as follows:

$$\begin{matrix}tA = - \$ -- \_\_\_ \_\_ \# \_\_\_ - @ -- -- \_ - \_\_\_ \\ tB = - \$ -- -- \_\_\_ \# - \_\_ - @ - \_\_\_ \_ -- \_\_ \\ tC = - \$ -- -- -- - \# \_ -- @ -- - \_\_\_ \_ - \\ tD = - \$ - \_\_ - \_\_ - \# \_\_ - @ - \_\_ - \_\_ - \_\_ \\ 0 \; 0 \; 0 \; 0 \; 0 \; 0 \; 0 \; 0 \; 001 \; 11111111 \\ 0 \; 1234567 \; 890 \; 12345678\end{matrix}$$

An array is created for each control variable (7-2). The table in FIG. 6 shows how the tables would be filled given the input as described in FIG. 1.

Referring to FIG. 6, the next state is mostly the index number plus one. The variable controls cause the next state to become frozen. In order to unfreeze the state, a control variable must first be activated. In this example, there are three variables. The value of −1 in the variable column indicates that the particular variable is inactive. Note that CTRL #3 is always active implying an unrestricted jumping operation. Converting the string expressions to the above array format above provides a convenient access for creating the final HDL output code (7-13 and 7-15).

Another array associates the index with a state assignment (7-10). The table in FIG. 6 need not be modified; only the state assignment is modified in order to try different configurations. State mappings may use more bits than the index.

A string class (XString.h) is also included that participates in the creation of the final HDL outputs (7-13 and 7-15). By using a fixed width font, dashes and underscores take the same amount of space. Dashes look like 1's and underscores look like 0's. Below is an example of a timing system that can be represented by a simple string expression:

My_signal=“---_-----______------_-_-”;

The reset signal sets the timing to the first character in the string. Thereafter on each clock, the next character becomes the next signal output. On the forth clock, the signal goes low for one clock period. When the last character of the string is reached, the sequence returns back to the beginning indefinitely. The Verilog state machine representation would typically be designed by a person skilled in the art as follows:

```
output My_signal;
reg [4:0] cnt;
assign My_signal =
!(
      (cnt ==3)
  | | ((cnt >=9) && ( cnt <=13))
  | | (cnt ==20)
  | | (cnt ==22)
);
always @ (posedge clk or posedge rst) begin
  if (rst) begin
    cnt <= 0;
  end
  else begin
    cnt <= cnt + 1;
    If (cnt >=24) cnt <= 0;
  end
end
```

As can be seen, the initial timing syntax is more visual and a lot less work that the state machine version. The state machine above uses a binary counter. Using the said program will produce a more optimal solution.

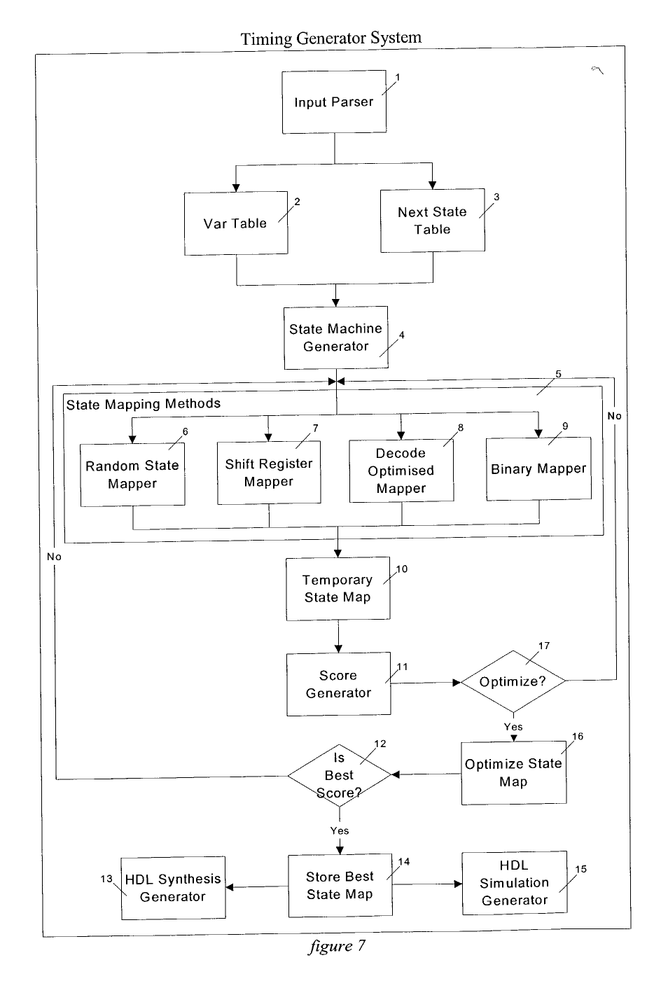

The conversion process to the Verilog language is performed differently depending upon the output style: Optimized for synthesis (see FIG. 2 also FIG. 7-13) and optimized for simulation (see FIG. 3 and FIG. 7-15).

The procedure for using the version optimized for simulation (7-15) is taken directly from the next state tables (7-3). The state mapping function from 7-14 is applied to each state so that the behavior will be exactly the same as the synthesis optimization version. The syntax for the Verilog language is well understood by persons skilled in the art, as well as that for VHDL. The current program supports the Verilog language. Someone skilled in the art could easily adapt the code to support the VHDL language.

The XString class (XString.h) provides support for creating sum of product formatting. The logic class (Logic.h) performs sum of product minimization. The logic class (Logic.h) is first initialized by the contents of the mapped Next State Tables (7-10). The logic function then creates a sum of product string that can be further formatted by the XString class (XString.h).

Additional utility functions are also provided including a template stack class (Stack.h), which helps to store variable names.

Once compiled, a logic synthesis program can perform optimized speed and logic reductions based on a pre-optimized result. A person skilled in the art could combine an existing logic synthesis program with this invention, thereby creating an improved logic synthesis program.

It is also possible to include timing syntax as a subset of an existing HDL language. A simulation program can utilize the timing syntax without having to build the underlying state machine controller. All that is needed is a simple pointer that advances on each clock to the next character of the timing string. When a timing control character is found, the pointer can be updated according to the Boolean value of the timing control character.

What is claimed is:

1. A text based hardware description language that includes as a subset of its syntax a string of characters visually representing one or more signals of a timing system which said string of characters may optionally include additional characters representing control signals that control the said timing system.

2. The hardware description language as defined in claim 1 that additionally includes repeated sub-timing expressions within the said string of characters where the said repeated expression contains a constant describing the number of times the said sub-timing expression is repeated whereby the said sub-timing expression is contained between two characters that bracket the said sub-timing expression whereby the said constant precedes the said brackets.

3. The hardware description language as defined in claim 2 that uses a variable in place of the said constant that controls the number of times the said sub-timing expression is repeated based upon the current value of the said variable which contents of said variable is externally modified.

4. A logic synthesis program that uses as its input the hardware description language as defined in claim 1.

5. A logic simulation program that uses as its input the hardware description language as defined in claim 1.

6. The hardware description language as defined in claim 1 that additionally includes syntax describing pipelined delays of one or more of the timing signals of the said timing system.

7. A hardware description language as defined in claim 1 that is combined with the Verilog language thereby creating a new language that includes all of the constructs of the Verilog language and the constructs of the said timing syntax as defined in claim 1.

8. A hardware description language as defined in claim 1 that is combined with the VHDL language thereby creating a new language that includes all of the constructs of the VHDL language and the constructs of the said timing syntax as defined in claim 1.

9. A computer program that receives as input from a file which said file comprises one or more strings containing one or more dash characters combined with one or more underscore characters, which said string represents the logic high states and logic low states of a timing system, which said string optionally contains a plurality of other characters representing timing control signals whereby the said computer program outputs a file configured as a state machine description in a hardware description language (HDL) which said state machine comprises:
states equal to the sum of string characters containing either a dash or an underscore character; and
optional control characters that modify the next state of the state machine; and
a decoder which decodes the states of the said state machine thereby creating a timing system.

10. The program of claim 9 where the characters representing the high and low states are replaced with different characters that represent in a similar way the high and low states of the said timing system.

11. The program of claim 9 where the hardware description language is Verilog.

12. The program of claim 9 where the hardware description language is VHDL.

13. The program of claim 9 where a plurality of state assignments are individually compared whereby the said program selects the said state assignment utilizing the lowest possible gate count.

14. The program of claim 9 where a plurality of state assignments are individually compared whereby the said program selects the said state assignment that optimizes the said timing system for clock speed.

15. The program of claim 9 where two output files are created in a single execution of the said program whereby one output file is optimized for simulation speed; and the second output file is optimized for improved synthesis.

16. A state machine optimization system comprising:
a logic evaluation function generator means; and
a memory table containing numbers representing the next state of the said state machine; and
a plurality of memory tables containing numbers representing the next state of the state machine associated with the activation of a control signal which said control signal replaces the next state with the said control variable number state; and
a memory table comprising a number mapping the said next state number with a different state number; and
a plurality of state mapping methods which create an optimized table of mapped states of the said state machine; and
a swapping function which systematically exchanges numbers contained in the said mapped memory table whereby the said logic evaluation function evaluates both an optimized state map and an optimized output decoder which said swapping function is executed repeatedly on each state thereby optimizing the number returned by the said logic evaluation function and creating both an optimized state assignment and an optimized output decoder for the said state machine.

17. A timing system, which uses the optimized state machine as defined in claim 16 where the decoder of the said state machine combines two or more states of the said state machine for each signal of the said timing system.

18. A timing system, which uses the optimized state machine as defined in claim 16 where the decode for each timing signal is fully defined by one of flip-flop in the said state machine whereby the output decoder logic is replaced by the said respective flip-flop.
